(19) United States
(12) Patent Application Publication
(10) Pub. No.: US 2006/0290157 A1
(43) Pub. Date: Dec. 28, 2006

(54) Trunk-specific functional arrangement for a motor vehicle

(76) Inventors: Hartmut Bohlke, Wuppertal (DE); Wolfgang Sitzler, Wuppertal (DE)

Correspondence Address: FLYNN THIEL BOUTELL & TANIS, P.C., 2026 RAMBLING ROAD, KALAMAZOO, MI, 49008-1631, US

(21) Appl. No.: 11/473,644

(22) Filed: Jun. 23, 2006

(30) Foreign Application Priority Data
Jun. 24, 2005 (DE) 10 2005 031 072.9

(51) Int. Cl. B60R 9/00

(52) U.S. Cl. 296/37.6

(57) ABSTRACT

A trunk-specific functional arrangement for a motor vehicle has a plurality of guide rails which are integrated in at least one boundary surface of the trunk and run, in particular, longitudinally and/or transversely in the boundary surface. At least one functional carriage is retained in a form-fitting manner in the guide rail and is arranged such that it can be displaced along the guide rail, and comprises at least one blocking apparatus which is designed for releasing or arresting the functional carriage. The functional carriage is mounted on the guide rail for rolling movement by at least one rolling element.

### CROSS-REFERENCE TO RELATED APPLICATIONS

This application is based on German Application No. 10 2005 031 072.9, filed Jun. 24, 2005, incorporated herein by reference.

### FIELD OF THE INVENTION

The invention relates to a trunk-specific functional arrangement for a motor vehicle, in particular for a passenger vehicle, having a plurality of guide rails which are integrated in at least one boundary surface of the trunk and run, in particular, longitudinally and/or transversely in the boundary surface, and having at least one functional carriage which is retained in a form-fitting manner in the guide rail and is arranged such that it can be displaced along the guide rail, and comprises at least one blocking means which is designed for releasing and arresting the functional carriage.

### BACKGROUND OF THE INVENTION

Such a trunk-specific functional arrangement is known from DE 101 49 186 B4. The known trunk-specific functional arrangement has at least one guide rail, which may be integrated in a trunk floor. At least one functional carriage designed as a load-bearing eyelet is arranged such that it can be displaced in the guide rail, and is provided with a manually actuable blocking element. The blocking element has a bolt which can engage in corresponding apertures of a perforated strip integrated in the guide rail. As soon as the corresponding bolt of the blocking element has latched into a corresponding aperture of the perforated strip, the functional carriage is blocked axially relative to the guide rail. Straightforward manual actuation of a button arranged in the functional carriage can release the bolt of the blocking element from the perforated strip again, as a result of which the functional carriage can once again be displaced relative to the guide rail. The functional carriage is retained in a crash-proof manner in the guide rail by virtue of having a T-shaped profile which is guided in a form-fitting manner in a C-shaped hollow profile of the guide rail.

### SUMMARY OF THE INVENTION

The object of the invention is to provide a trunk-specific functional arrangement of the type mentioned in the introduction which allows crash-proof anchoring of the functional carriage in the guide rail and, nevertheless, smooth displaceability of the functional carriage.

This object is achieved in that the functional carriage is mounted for rolling movement on the guide rail by means of at least one rolling element. The rolling friction which is achieved reduces the frictional resistance during displacement of the functional carriage within the guide rail, so that it is possible to achieve particularly smooth axial displacement of the functional carriage relative to the guide rail. A user thus needs to exert just a relatively low level of force in order to displace the functional carriage. In particular in those regions of a trunk which, ergonomically, are relatively difficult for a user to reach, the handling of the at least one functional carriage is made considerably easier.

In one configuration of the invention, the at least one rolling element rests on the outside of the guide rail. The very weight of the functional carriage thus pushes the at least one rolling element onto the guide rail from above, so as to ensure that the functional carriage rests, and rolls, reliably on the guide rail.

In a further configuration of the invention, each functional carriage is provided with at least two rolling-element axles. The functional carriage thus forms a kind of rolling carriage which rests in a statically determined manner on the guide rail by way of its at least two rolling-element axles. It is possible to provide here as the rolling elements for each rolling-element axle in each case a continuous roller or two rolling elements which flank the functional carriage on both sides, for example wheels, disks, balls or the like.

In a further configuration of the invention, at least two guide rails are provided, these being spaced apart parallel to one another and having in each case at least one functional carriage mounted for rolling movement in them. This further increases the possible uses of the trunk-specific functional arrangement and the variability thereof.

In a further configuration of the invention, a dimensionally stable carrier body is provided, this extending between the guide rails and being connected to the functional carriages. The dimensionally stable carrier body extends transversely to the longitudinal orientation of the guide rails and may be provided, in particular, for securing stowed goods, for dividing up the trunk into a number of horizontally or vertically adjacent sections or for separating off the trunk from a passenger compartment.

In a further configuration of the invention, the carrier body is configured as a planar panel which is borne by the functional carriages. This planar panel may also advantageously be configured as a displaceable trunk floor. As an alternative, it can be used for partitioning two trunk sections from one another or for similar functions.

In a further configuration of the invention, the carrier panel is mounted on the two functional carriages such that it can be pivoted about a common pivot axis. It is thus possible for the carrier panel, in particular, both to be positioned vertically and to be used horizontally.

In a further configuration of the invention, at least one anchoring element for fastening at least one pulling means is provided on the carrier body. The anchoring element is designed, in particular, as a load-bearing eyelet.

In a further configuration of the invention, in the region of their top side, the guide rails are provided with at least one aperture for the removal or insertion of at least one functional carriage. Depending on requirements, it is thus possible for a functional carriage to be inserted into a corresponding guide rail, or removed therefrom, manually by a corresponding user, preferably without the aid of tools. The at least one aperture is preferably provided in an end region of the respective guide rail, so that the rest of the length of the guide rail can be used for guiding and securing the corresponding functional carriage.

In a further configuration of the invention, means are provided to fix the carrier panel in a releasable manner in an upright, preferably a vertical, separating position in the trunk. It is thus possible to position the carrier panel upright and use it as a separating panel for two trunk sections.

In a further configuration of the invention, at least two functional carriages are fastened on the carrier panel such that they are spaced apart from the functional carriages provided with the pivot axis. By means of these functional carriages, the carrier panel, in its horizontal, floor position, rests on a total of four functional carriages and is thus supported reliably and can roll to good effect.

In a further configuration of the invention, the blocking means, for releasing or arresting the functional carriage, comprise a movable actuating button which projects through an aperture in the carrier panel and is accessible from above in a horizontal, floor position of the carrier panel. It is thus possible, with the carrier panel resting on the functional carriages, to release or arrest the functional carriage in an ergonomically favorable manner.

Further advantages and features of the invention can be gathered from the claims and from the following description of a preferred exemplary embodiment of the invention which is illustrated with reference to the drawings, in which:

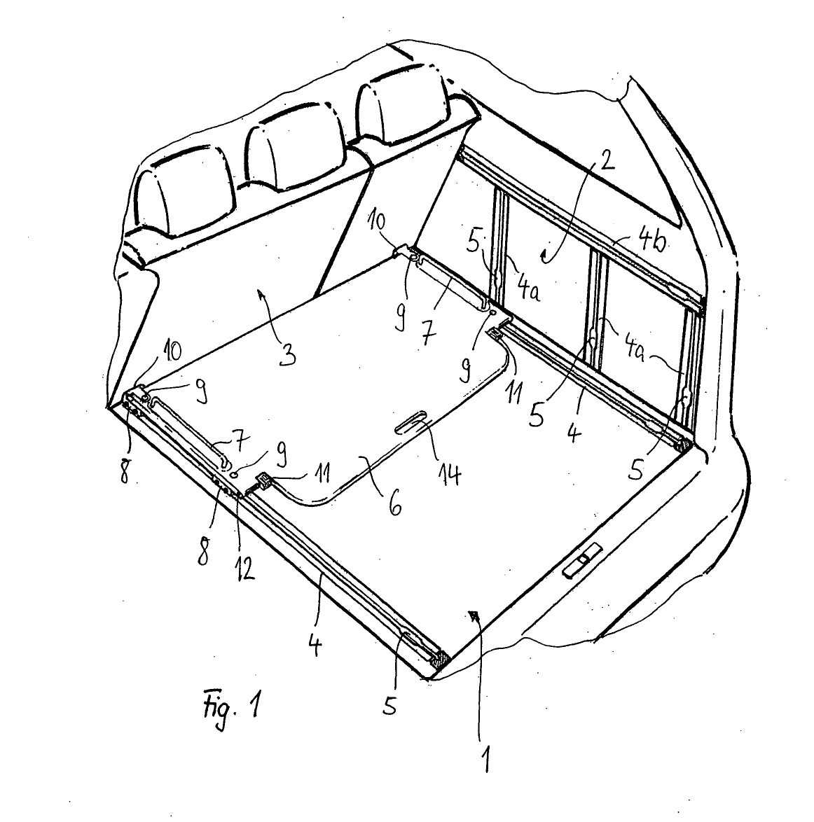

FIG. 1 shows a perspective illustration of a trunk of a station wagon with one embodiment of a trunk-specific functional arrangement according to the invention,

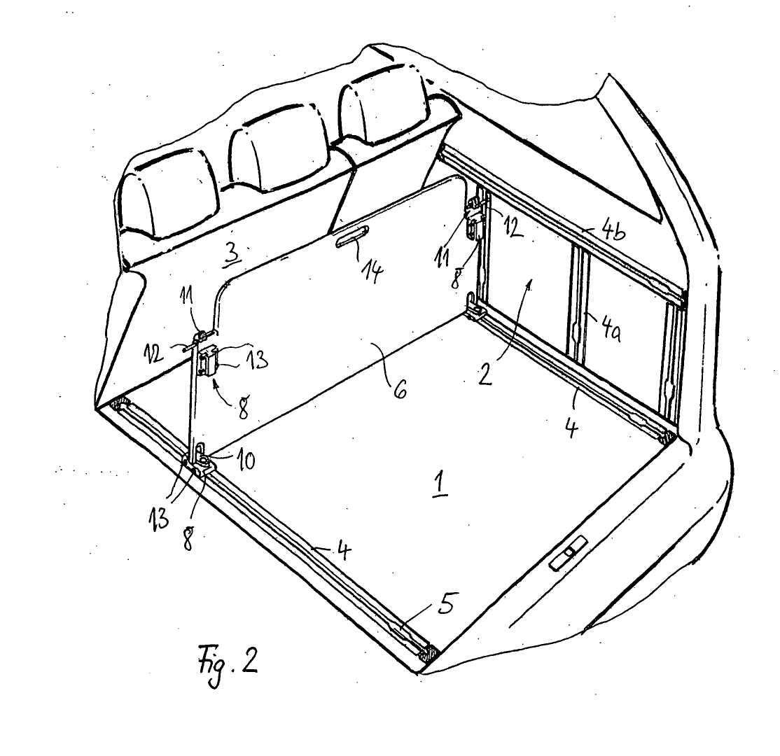

FIG. 2 shows the trunk according to FIG. 1 with the trunk-specific functional arrangement, a carrier panel being illustrated in the upright, separating position,

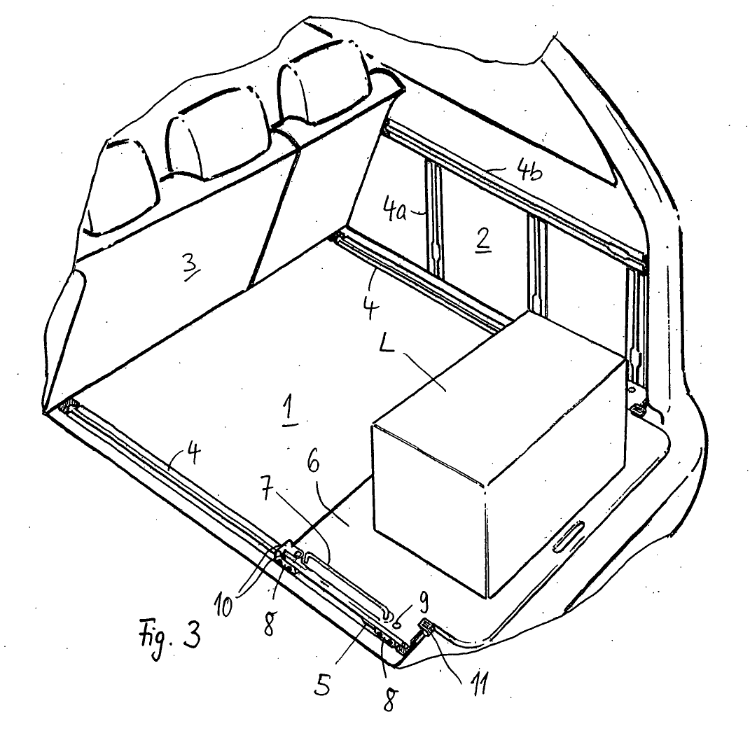

FIG. 3 shows the trunk-specific functional arrangement according to FIGS. 1 and 2, the carrier panel being used as a displaceable floor panel,

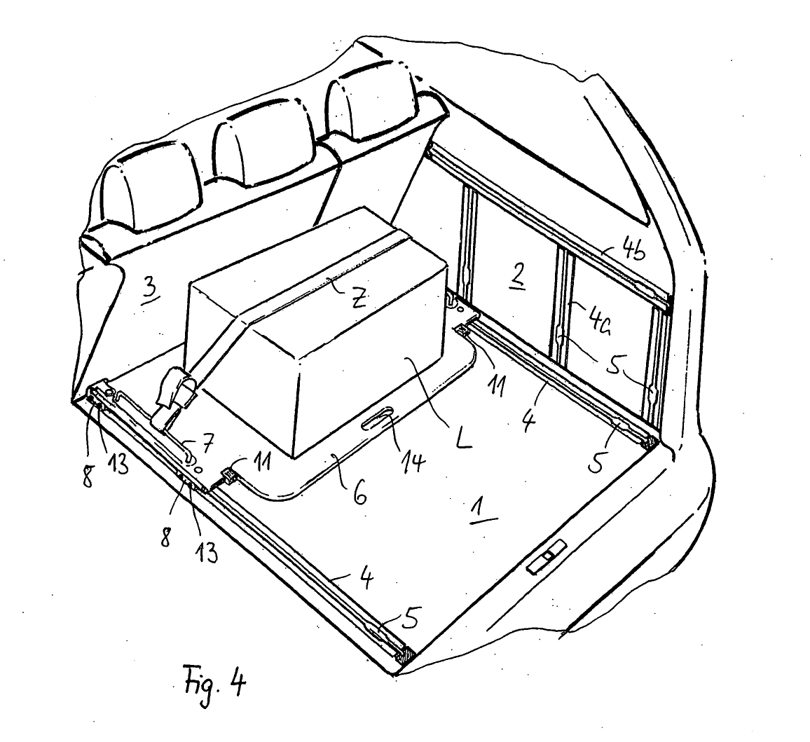

FIG. 4 shows the trunk-specific functional arrangement according to FIG. 3 in another functional position,

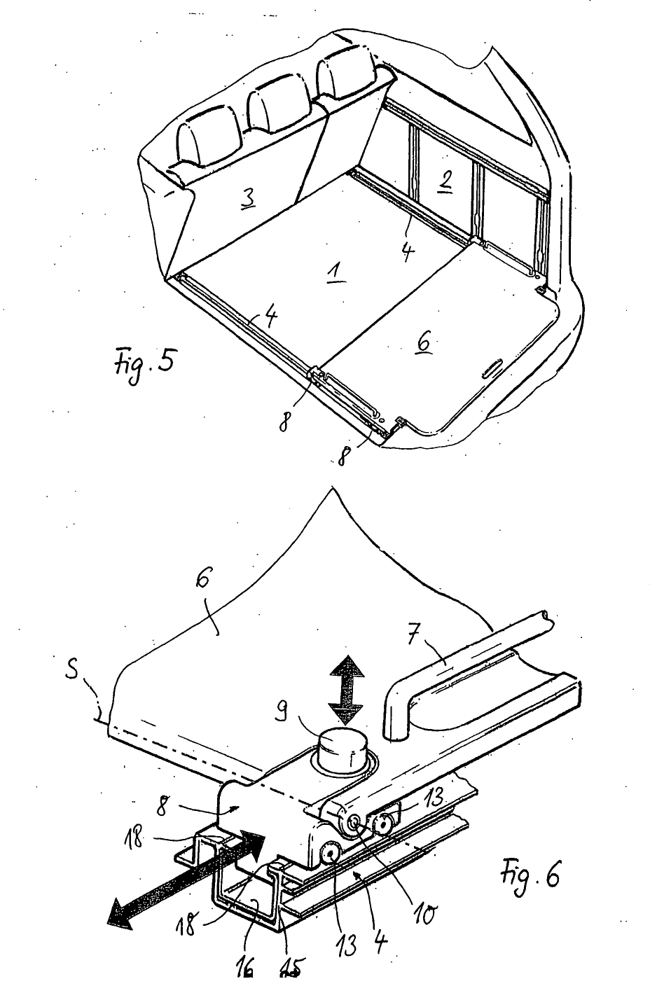

FIG. 5 shows a reduced-scale illustration of the trunk according to FIGS. 1 to 4 with a displaceable carrier panel oriented horizontally,

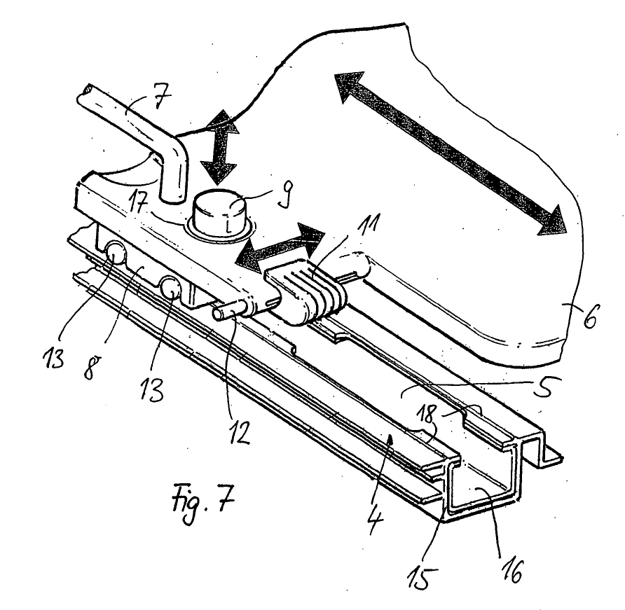

FIG. 6 shows an enlarged, perspective illustration of a detail of the trunk-specific functional arrangement according to FIGS. 1 to 5, and

FIG. 7 shows an enlarged, perspective illustration of a further detail of the trunk-specific functional arrangement according to FIGS. 1 to 6.

### DETAILED DESCRIPTION OF THE INVENTION

A motor vehicle in the form of a station wagon has, according to FIGS. 1 to 7, a trunk which is arranged in a rear region of the motor vehicle, behind a rear seat bench 3, and is accessible from the rear of the vehicle via an openable tailgate. The trunk has a trunk floor 1 which is bounded, toward the front, by a backrest arrangement of the rear seat bench 3 and, toward the mutually opposite sides of the vehicle, by a respective side wall 2. The guide rails 4, 4a, 4b are integrated both in the trunk floor 1 and in the mutually opposite side walls 2 such that the guide rails 4 to 4b have their top sides terminating at least largely flush with the corresponding trunk-boundary surface, in particular the trunk floor 1 or one of the two side walls 2. The guide rails 4, 4a, 4b are fastened in crash-proof manner in the trunk. Two guide rails 4 extend parallel to one another, and in the longitudinal direction of the vehicle, in the region of the trunk floor 1, these two guide rails 4 being provided on mutually opposite side-border regions of the trunk floor 1. A plurality of guide rails 4 extend upward, preferably vertically upward, parallel to one another in the side walls. The side walls 2 are configured in a planar manner, at least up to the top guide rails 4b, and are oriented at right angles to the horizontal trunk floor 1. The side walls 2 are thus oriented in mutually parallel vertical planes. Above the guide rails 4a, a respective guide rail 4b extends horizontally, as seen in the longitudinal direction of the vehicle, over the length of the trunk. According to FIGS. 6 and 7, all the guide rails 4 to 4b have a carrier profile 15, which is anchored in the respective boundary surface. Each carrier profile 15 has an essentially C-shaped cross-sectional profile provided with a continuous longitudinal groove in the plane of the respective boundary surface. A perforated profile 16 is arranged flush in each carrier profile 15 and, corresponding to the C-shaped cross-sectional profile, is likewise provided with a, somewhat smaller, C-shaped cross-sectional profile. The perforated profile 16 is thus also open in the direction of its top side. A base of the perforated profile 16 is provided with a row of latching holes which are spaced apart from one another preferably uniformly in the longitudinal direction and the function of which will be described more specifically hereinbelow. The latching function of the row of latching holes corresponds to the latching function of the perforated strip described in DE 101 49 186 B4.

At least one functional carriage 8 can be inserted in each of the guide rails 4 to 4b described. As can be seen with reference to FIGS. 1 to 7, such a functional carriage 8 is designed as a sliding carriage comprising two roller axles with a total of four rolling elements 13. Provided on the top side of the carrier profile 15 of each guide rail 4 to 4b are flat guiding crosspieces 18 which extend in the longitudinal direction of the respective guide rail 4 to 4b and provide a rail-like longitudinal guide for the sliding carriage and, in particular, the rolling elements 13. The rolling elements 13 run on the top side of the respective guide rail 4 to 4b. Each functional carriage or sliding carriage 8 is provided with a T-shaped securing profile which is guided in the groove of the corresponding guide rail 4 to 4b. Each guide rail 4 to 4b has aperture regions 5 at which the sliding carriages 8 can be removed from the groove of the respective guide rail 4 to 4b, or inserted into the same, by way of their T-shaped securing profiles. It is possible, in a manner which is not illustrated, for each functional carriage 8 to be designed, in the manner described, as a single part and thus to be configured, for example, for receiving a load-bearing eyelet according to DE 101 49 186 B4. It is also possible for such functional carriages to be inserted, in particular, into the guide rails 4, 4a and 4b of the vertical side walls 2 and arrested there.

Each functional carriage 8, be this in the form of a single part or in accordance with the embodiment of FIGS. 1 to 7, is provided with a blocking mechanism, of which the basic construction corresponds to the arresting mechanism of DE 101 49 186 B4. In a manner which is not illustrated specifically, a latching bolt is mounted in each functional carriage 8 for movement in the direction transverse to the sliding direction of the functional carriage 8, in order to be able to engage in a corresponding latching hole of the perforated profile 16. An actuating button 9 serves for latching the latching bolt in the corresponding latching hole or releasing it therefrom. For this purpose, in a manner which is known in principle, the latching bolt is assigned a restoring spring which transfers the latching bolt into the unlocked position.

In the case of the exemplary embodiment illustrated according to FIGS. 1 to 7, a total of four functional carriages 8 are connected to one another by a common carrier panel 6 which extends over the width of the trunk and over somewhat less than half the length of the trunk floor 1. The carrier panel 6 is of dimensionally stable design and, on its mutually opposite side-border regions, is provided with in each case two functional carriages 8, which are located opposite one another in pairs on the same level. The two front functional carriages 8, as seen in the longitudinal direction of the vehicle, each have pivot-bearing means 10 for the carrier panel 6, as a result of which the carrier panel 6 is mounted such that it can be pivoted about a pivot axis S (FIG. 6), running in the transverse direction of the vehicle, relative to the two front functional carriages 8. The two rear functional carriages 8 are fastened on the underside of the carrier panel 6 (FIG. 2). In order to allow the actuating button 9 for each functional carriage 8 to be actuated from above, a corresponding aperture 17 is provided in the carrier panel 6 (FIG. 7).

The carrier panel 6 is mounted such that it can be displaced along the two guide rails 4, which are recessed in the trunk floor 1, by the total of four functional carriages 8, which are designed as sliding carriages. A rear horizontal end position of the carrier panel 6 is illustrated by FIGS. 3 and 5. A front end position, as seen in the normal direction of travel, in which the carrier panel 6 butts against the backrest arrangement of the rear seat bench 3, is illustrated in FIGS. 1 and 4.

In order for it then to be possible to transfer the carrier panel 6 into a vertical, separating position according to FIG. 2, the carrier panel is first of all displaced in the rearward direction until the two rear functional carriages 8 are located level with the rear apertures 5 of the guide rails 4. In the region of these apertures 5, the T-shaped securing profiles of the functional carriages 8 are exposed, so that the carrier panel 6 can be pivoted upward. In order to allow the carrier panel 6 to be arrested in its upright, separating position, arresting means in the form of two slides 11, 12 are provided, it being possible for these to engage in the vertical guide grooves of mutually opposite guide rails 4a. The arresting means 11, 12 each comprise a securing pin 12 which, by means of a manually operable sliding member 11, can be displaced into its securing position according to FIG. 7 or into its rest position, in which it is recessed in the carrier panel 6, according to FIGS. 1, 3 and 4.

In order to transfer the carrier panel 6 out of the vertical, separating position into a horizontal, floor position again, first of all the securing pins 12 are pushed inward by means of the actuating slides 11, as a result of which they are freed from the guide rails 4a. The carrier panel 6 can then be swung round to the rear and is then displaced to the rear, as seen in the longitudinal direction of the vehicle, until the rear functional carriages 8 slide into the apertures 5 of the guide rails 4 again. The carrier panel 6 is then located in its floor position, in which it is mounted such that it can be displaced in the longitudinal direction of the vehicle, parallel to the surface of the trunk floor 1.

Two lashing brackets 7 are provided on mutually opposite sides of the carrier panel 6 and serve as anchoring elements for pulling means, in particular for an adjustable pulling strap Z. Such a pulling strap Z can be used to secure stowed goods L on the carrier panel 6. The carrier panel 6 is additionally provided with a gripping aperture 14, in order to make it easier for the carrier panel 6 to be gripped manually.

It is also possible for the carrier panel 6 to be completely removed from the rail system in the trunk by the front functional carriages 8, in addition to the rear functional carriages 8, also being disengaged from the guide rails 4 in the region of the apertures 5.

What is claimed is:

1. Trunk-specific functional arrangement for a motor vehicle, in particular for a passenger vehicle, having a plurality of guide rails which are integrated in at least one boundary surface of the trunk and run, in particular, longitudinally and/or transversely in the boundary surface, and having at least one functional carriage which is retained in a form-fitting manner in the guide rail and is arranged such that it can be displaced along the guide rail, and comprises at least one blocking means which is designed for releasing or arresting the functional carriage, characterized in that the functional carriage (8) is mounted for rolling movement on the guide rail (4, 4a, 4b) by means of at least one rolling element (13).

2. Trunk-specific functional arrangement according to claim 1, characterized in that at least one rolling element (13) rests on the outside of the guide rail (4 to 4b).

3. Trunk-specific functional arrangement according to claim 1, characterized in that each functional carriage (8) is provided with two rolling-element axles.

4. Trunk-specific functional arrangement according to claim 1, characterized in that at least two guide rails (4) are provided, these being spaced apart parallel to one another and having in each case at least one functional carriage (8) mounted for rolling movement in them.

5. Trunk-specific functional arrangement according to claim 4, characterized in that a dimensionally stable carrier body (6) is provided, this extending between the guide rails (4) and being connected to the functional carriages (8).

6. Trunk-specific functional arrangement according to claim 5, characterized in that the carrier body (6) is configured as a planar panel (6) which is borne by the functional carriages (8).

7. Trunk-specific functional arrangement according to claim 6, characterized in that the carrier panel (6) is mounted on the two functional carriages (8) such that it can be pivoted about a common pivot axis (S).

8. Trunk-specific functional arrangement according to claim 5, characterized in that at least one anchoring element (7) for fastening at least one pulling means (Z) is provided on the carrier body (6).

9. Trunk-specific functional arrangement according to claim 1, characterized in that, in the region of their top side, the guide rails (4 to 4b) are provided with at least one aperture (5) for the removal or insertion of at least one functional carriage (8).

10. Trunk-specific functional arrangement according to claim 5, characterized in that means (11, 12) are provided to fix the carrier panel (6) in a releasable manner in an upright, preferably a vertical, separating position in the trunk.

11. Trunk-specific functional arrangement according to claim 7, characterized in that at least two functional carriages (8) are fastened on the carrier panel (6) such that they are spaced apart from the functional carriages (8) provided with the pivot axis.

12. Trunk-specific functional arrangement according to claim 11, characterized in that the blocking means, for releasing or arresting the two functional carriages (8), comprise a movable actuating button (9) which projects through an aperture (17) in the carrier panel (6) and is accessible from above in a horizontal, floor position of the carrier panel (6).
